(19) United States
(12) Patent Application Publication
(10) Pub. No.: US 2025/0392883 A1
(43) Pub. Date: Dec. 25, 2025

(54) SYSTEM AND METHOD FOR LOCATION MANAGEMENT IN A NETWORK

(71) Applicant: JIO PLATFORMS LIMITED, Ahmedabad (IN)

(72) Inventors: Aayush BHATNAGAR, Navi Mumbai (IN); Vikash AGRAWAL, Navi Mumbai (IN); Vikram LIMAN, Navi Mumbai (IN); Omprakash KUSHWAH, Madhya Pradesh (IN)

(73) Assignee: JIO PLATFORMS LIMITED, Ahmedabad (IN)

(21) Appl. No.: 18/880,388

(22) PCT Filed: Mar. 11, 2024
(86) PCT No.: PCT/IN2024/050245

§ 371 Date: Dec. 31, 2024

(30) Foreign Application Priority Data
Mar. 29, 2023 (IN) 202321023227

(51) Int. Cl. H04W 4/029; H04L 67/02; H04W 64/00

(52) U.S. Cl. CPC H04W 4/029; H04L 67/02; H04W 64/00

(57) ABSTRACT

The present disclosure provides a system (120) and a method for location management in a network. The system (120) is integrated with a location management function (LMF) (110). The system (120) includes a hypertext transfer protocol 2 (HTTP2) stack (112) in the system such that the network is capable to manage incoming requests from various user equipments (UEs) in an efficient manner. Hence, the system (120) generates higher speed and efficiency while processing requests. Further, the system (120) processes pending requests based on a configured time and prevents disruption in the network.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The embodiments of the present disclosure generally relate to systems and methods for location management in a telecommunication network. More particularly, the present disclosure relates to a system and a method for an efficient location management in a network that is efficient and integrates with other functionalities in the Fifth Generation (5G) network to process network induced requests at a higher speed.

### DEFINITION

As used in the present disclosure, the following terms are generally intended to have the meaning as set forth below, except to the extent that the context in which they are used to indicate otherwise.

The expression ‘hypertext transfer protocol version 2 (HTTP2) protocol used hereinafter in the specification refers to an updated version of the HTTP protocol used for communication between web servers and clients. The HTTP2 protocol is designed to improve the speed and efficiency by allowing for caching of resources and multiplexing of requests.

The expression ‘hypertext transfer protocol version 2 (HTTP2) stack used hereinafter in the specification refers to a combination of software components and libraries that enable support for a HTTP/2 protocol in a web application or server. The HTTP2 stack refers to a set of technologies and tools that work together to accomplish a specific goal. The HTTP2 stack is a modular architecture consisting of several layers, including the network layer, transport layer, and application layer.

These definitions are in addition to those expressed in the art.

### BACKGROUND OF THE INVENTION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admission of the prior art.

Fifth Generation (5G) networks are readily used for driving various applications including high-speed automation systems. As 5G networks provide higher speeds and lower latency, 5G networks are predominantly used in machine-to-machine communications and mobile broadband communication systems. Considering 5G applications having high transaction (requests) per second, multiple chunks of data may be received for a single request. Hence, 5G applications may be less efficient in handling a higher time-sensitive packet switch (TPS). Further, conventional systems utilize a hypertext transfer protocol 2 (HTTP2) that uses a single transmission control protocol (TCP) connection to send multiple streams of data for resource management. However, due to higher incoming requests from various resources, conventional systems are unable to provide the required speed and efficiency and are not able to prevent blocking between resources.

There is, therefore, a need in the art to provide a system and a method that can mitigate the problems associated with the prior arts.

### OBJECTS OF THE INVENTION

Some of the objects of the present disclosure, which at least one embodiment herein satisfies are listed herein below.

It is an object of the present disclosure to provide a system and a method that is capable to manage incoming requests in an efficient manner with the help of an integrated hypertext transfer protocol 2 (HTTP 2) stack, thereby improving the efficiency and speed of the system.

It is an object of the present disclosure to provide a system and a method where the HTTP2 stack functionality is integrated within a location management function (LMF) to handle various incoming requests efficiently.

It is an object of the present disclosure to provide a system and a method where the HTTP2 stack functionality provides bundled up formation for all data chunks and provides readymade information that can be easily processed.

It is an object of the present disclosure to provide a system and a method where the HTTP2 stack functionality retries pending requests based on configured time and uses a retry channel functionality that prevents disconnections.

It is an object of the present disclosure to provide a system and a method where the LMF manages the overall co-ordination and scheduling of resources required for the location of a user equipment (UE) that is registered with or accessing a network.

It is an object of the present disclosure to provide a system and a method where the LMF calculates or verifies a final location and a velocity estimate to achieve the desired accuracy.

It is an object of the present disclosure to provide a system and a method where the LMF interacts with the UE in order to exchange location information applicable to UE assisted, UE based position methods.

It is an object of the present disclosure to provide a system and a method where the LMF interacts with a new generation-radio access network (NG-RAN), a non-third generation partnership project (3GPP) interworking function (N3IWF) or a trusted non-3GPP access network (TNAN) in order to obtain location information.

It is an object of the present disclosure to provide a system and a method that enhances a tractability function and further enhances the communication system.

### SUMMARY

The present disclosure discloses a system for providing location assistance in a network. The system includes at least one network element and a location management function (LMF). The at least one network element is configured to generate at least one request for providing a location of a target user equipment (UE). The location management function (LMF) having a hypertext transfer protocol version 2 (HTTP2) stack is coupled to the at least one network element to receive the generated request. The LMF is configured to process the received request to determine a current location of the target UE based on a number of parameters. The LMF is configured to communicate the determined current location to the at least one network element.

In an embodiment, the at least one network element includes at least one serving AMF, a gateway mobile location centre (GMLC), and a location services (LCS) client.

In an embodiment, each request includes at least one or more of a unique header, a plurality of data frames, required quality of service (QoS), a list of supported geographical area description (GAD) shapes, and a type of LCS client.

In an embodiment, the HTTP2 stack is configured to receive the plurality of data frames in a sequential order.

In an embodiment, the number of parameters include downlink location measurements obtained from the target UE, uplink location measurements obtained from a NG-RAN (Next Generation Radio Access Network), location measurements obtained from a public land mobile network (PLMN), a determined quality of service (QoS), and the type of LCS client.

In an embodiment, the HTTP2 stack includes multiple listeners for handling incoming requests from the at least one network element and performing a number of tasks such as accepting and processing HTTP requests, managing connections, and generating HTTP responses.

In an embodiment, the HTTP2 stack is configured to extract a stream Id value corresponding to each received request.

In an embodiment, the HTTP2 stack is configured to consolidate the unique header and the plurality of data frames based on the extracted stream Id value to generate a single object.

In an embodiment, the system is configured to interact with the target UE in order to exchange location information applicable to UE assisted methods, and UE based position methods, and is further configured to interact with a plurality of resources in order to obtain the location information.

In an embodiment, the plurality of resources includes the NG-RAN, a non-3GPP Interworking Function (N3IWF) and a trusted non-3GPP access network (TNAN).

In an embodiment, the HTTP2 stack (314) includes at least one request counter, and at least one response counter for verifying a current incoming request threshold.

In an embodiment, the system is configured to be employed as a plug and play for an application catering HTTP2 requests and HTTP2 responses.

In an embodiment, the system is configured to support a request for periodic or triggered location received from the at least one serving AMF for the target UE and send determined UE location directly to the GMLC.

In an embodiment, the system is configured to manage co-ordination and scheduling of the plurality of resources required for the location of the target UE.

In an embodiment, the system is configured to verify the determined UE location by performing a latitude/longitude/velocity estimation procedure.

The present disclosure discloses a network entity for providing location assistance in a network. The network entity is coupled to at least one network element receive. The at least one network element is configured to generate at least one request for providing a location of a target user equipment (UE). The network entity includes a location management function (LMF) having a hypertext transfer protocol version 2 (HTTP2) stack is coupled to the at least one network element to receive the generated at least one request. The LMF is configured to process the received request to determine a current location of the target UE based on a number of parameters. The LMF is configured to communicate the determined current location to the at least one network element.

The present disclosure discloses a method of providing location assistance in a network. The method includes generating, by at least one network element, at least one request for providing a location of a target user equipment (UE). The method includes receiving, by a location management function (LMF) having a hypertext transfer protocol version 2 (HTTP2) stack, the generated at least one request from the at least one network element. The method includes processing, by the LMF, the received request to determine a current location of the target UE based on a number of parameters. The method includes communicating, via the LMF, the communicate the determined current location to the at least one network element.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an exemplary network architecture of a system for providing location assistance in a network, in accordance with an embodiment of the present disclosure.

FIG. 2 illustrates an exemplary representation of the system for providing location assistance in the network, in accordance with an embodiment of the present disclosure.

FIG. 3 illustrates an exemplary process for implementing the system for providing location assistance in the network, in accordance with an embodiment of the present disclosure.

FIG. 4 illustrates an exemplary process used by the system for providing location assistance in the network, in accordance with an embodiment of the present disclosure.

FIG. 5 illustrates an exemplary mobile terminating-location request (MT-LR) process performed by the system for providing location assistance in the network, in accordance with an embodiment of the present disclosure.

FIG. 6 illustrates an exemplary mobile originating-location request (MO-LR) process performed by the system for providing location assistance in the network, in accordance with an embodiment of the present disclosure.

FIG. 7 illustrates an exemplary network induced-location request (NI-LR) performed by the system for providing location assistance in the network, in accordance with an embodiment of the present disclosure.

FIG. 8 illustrates an exemplary computer system in which or with which the system may be implemented, in accordance with an embodiment of the present disclosure.

The foregoing shall be more apparent from the following more detailed description of the disclosure.

### List of Reference Numerals

100—Network Architecture
102-1, 102-2 . . . 102-N—Users
104-1, 104-2 . . . 104-N—User Equipments
108—Network Element(s)
110, 306, 402—Location Management Function (LMF)
112—HTTP2 stack
120—System
202—One or more processor(s)
204—Memory
206—A Plurality of Interfaces
208—Processing Engine
210—Data Acquisition Engine
212—Database
302—Element Management System (EMS)
304—Operation, Administration, And Maintenance (OAM) Module
308—Access and Mobility Management Function (AMF)
310—Other LMF
312—Database
404—HTTP2 stack
406—long term evolution (LTE) positioning protocol (LPP) communication module
408—5G new radio (NR) positioning protocol (NRPPa) communication module
410—Latitude/Longitude/Velocity Report Module
412—Location Engine Module
810—External Storage Device
820—Bus
830—Main Memory
840—Read Only Memory
850—Mass Storage Device
860—Communication Port
870—Processor

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above. Some of the problems discussed above might not be fully addressed by any of the features described herein. Example embodiments of the present disclosure are described below, as illustrated in various drawings in which like reference numerals refer to the same parts throughout the different drawings.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is to describe particular embodiments only and is not intended to be limiting the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items. It should be noted that the terms “mobile device”, “user equipment”, “user device”, “communication device”, “device” and similar terms are used interchangeably for the purpose of describing the invention. These terms are not intended to limit the scope of the invention or imply any specific functionality or limitations on the described embodiments. The use of these terms is solely for convenience and clarity of description. The invention is not limited to any particular type of device or equipment, and it should be understood that other equivalent terms or variations thereof may be used interchangeably without departing from the scope of the invention as defined herein.

As used herein, an “electronic device”, or “portable electronic device”, or “user device” or “communication device” or “user equipment” or “device” refers to any electrical, electronic, electromechanical, and computing device. The user device is capable of receiving and/or transmitting one or parameters, performing function/s, communicating with other user devices, and transmitting data to the other user devices. The user equipment may have a processor, a display, a memory, a battery, and an input-means such as a hard keypad and/or a soft keypad. The user equipment may be capable of operating on any radio access technology including but not limited to IP-enabled communication, Zig Bee, Bluetooth, Bluetooth Low Energy, Near Field Communication, Z-Wave, Wi-Fi, Wi-Fi direct, etc. For instance, the user equipment may include, but not limited to, a mobile phone, smartphone, virtual reality (VR) devices, augmented reality (AR) devices, laptop, a general-purpose computer, desktop, personal digital assistant, tablet computer, mainframe computer, or any other device as may be obvious to a person skilled in the art for implementation of the features of the present disclosure.

Further, the user device may also comprise a “processor” or “processing unit” includes processing unit, wherein processor refers to any logic circuitry for processing instructions. The processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor is a hardware processor.

As portable electronic devices and wireless technologies continue to improve and grow in popularity, the advancing wireless technologies for data transfer are also expected to evolve and replace the older generations of technologies. In the field of wireless data communications, the dynamic advancement of various generations of cellular technology are also seen. The development, in this respect, has been incremental in the order of second generation (2G), third generation (3G), fourth generation (4G), and now fifth generation (5G), and more such generations are expected to continue in the forthcoming time.

Radio Access Technology (RAT) refers to the technology used by mobile devices/user equipment (UE) to connect to a cellular network. It refers to the specific protocol and standards that govern the way devices communicate with base stations, which are responsible for providing the wireless connection. Further, each RAT has its own set of protocols and standards for communication, which define the frequency bands, modulation techniques, and other parameters used for transmitting and receiving data. Examples of RATs include GSM (Global System for Mobile Communications), CDMA (Code Division Multiple Access), UMTS (Universal Mobile Telecommunications System), LTE (Long-Term Evolution), and 5G. The choice of RAT depends on a variety of factors, including the network infrastructure, the available spectrum, and the mobile device's/device's capabilities. Mobile devices often support multiple RATs, allowing them to connect to different types of networks and provide optimal performance based on the available network resources.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

For numerous new applications that rely on precise position awareness and other contextual data, the 5G wireless ecosystem is necessary. In a 5G wireless ecosystem, an application requires high transaction (requests) per second, such that multiple chunks of data for single request is generated. The seamless integration of global navigation satellite system (GNSS) and modern 5G wireless technologies allow for faster and more accurate location determination using contextual data. Furthermore, the conventional systems are complex and costly in practical applications.

The present disclosure discloses a system and method of the location management function (LMF), specifically for location assistance in a network. The system is capable to manage the counter and incoming requests in an efficient manner with the help of integrated HTTP 2 Stack, and thereby the efficiency and speed of the system to process “determine location request” has been increased.

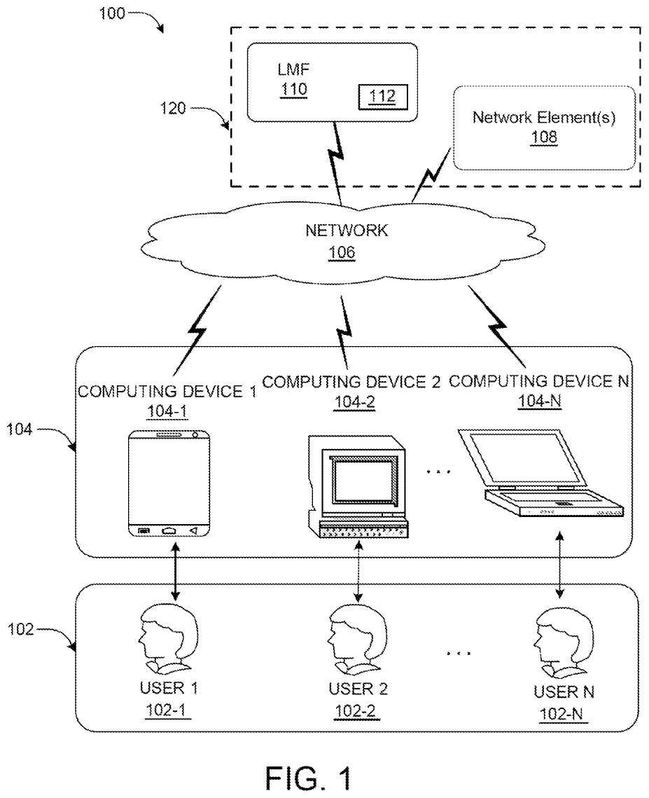

The various embodiments throughout the disclosure will be explained in more detail with reference to FIG. 1-FIG. 8.

FIG. 1 illustrates an exemplary network architecture (100) of a system (referred as “system 120”) for providing location assistance in a network (106), in accordance with an embodiment of the present disclosure.

As illustrated in FIG. 1, the system (120) includes at least one network element (108) and a location management function (LMF) (110). In an example, the system (120) may be integrated with the location management function (LMF) (110), therefore also known as the LMF. In another aspect, the system (120) may be implemented as a network entity for providing location assistance in the network (106).

The at least one network element (108) is configured to generate at least one request for providing a location of a target user equipment (UE). For example, each request includes at least one or more of a unique header, a plurality of data frames, required quality of service (QoS), a list of supported geographical area description (GAD) shapes, and a type of LCS client. In an aspect, a network operator is configured to generate the request for location assistance in the network. In an example, the at least one network element includes at least one serving Access and Mobility Management Function (AMF), a gateway mobile location centre (GMLC), and a location services (LCS) client. In an aspect, a user is also able to raise a request for locating a user equipment using by the user.

The location management function (LMF) (110) includes a hypertext transfer protocol version 2 (HTTP2) stack (112). The LMPF (110) is coupled to the at least one network element to receive the generated request. The LMF is configured to process the received request to determine a current location of the target UE based on a number of parameters. In an example, the number of parameters include downlink location measurements obtained from the target UE, uplink location measurements obtained from a NG-RAN (Next Generation Radio Access Network), location measurements obtained from a public land mobile network (PLMN), a determined quality of service (QoS), and the type of LCS client.

As illustrated in FIG. 1, one or more user equipments (UEs) (104-1, 104-2 . . . 104-N) are connected to the system (120) through the network (106). A person of ordinary skill in the art will understand that the one or more user equipments (104-1, 104-2 . . . 104-N) may be collectively referred as user equipments (UEs) (104) and individually referred as user equipment (UE) (104). A person of ordinary skill in the art will understand that the one or more users (102-1, 102-2 . . . 102-N) may be collectively referred as users (102) and individually referred as user (102).

In an embodiment, the UE (104) includes, but not be limited to, a mobile, a laptop, etc. Further, the UE (104) includes one or more in-built or externally coupled accessories including, but not limited to, a visual aid device such as a camera, audio aid, microphone, or keyboard. Further, the UE (104) includes a mobile phone, smartphone, virtual reality (VR) devices, augmented reality (AR) devices, a laptop, a general-purpose computer, a desktop, a personal digital assistant, a tablet computer, and a mainframe computer. Additionally, input devices for receiving input from the user (102) such as a touchpad, touch-enabled screen, electronic pen, and the like may be used. In an embodiment, users/customers (102) may submit their complaints through the UEs (104) as shown in FIG. 1.

In a communication system, the user equipment (UE) (104) sends a session establishment message to an Access and Mobility Management Function (AMF). The AMF then selects a Session Management Function (SMF) based on the session establishment message and sends the message to the selected SMF. Once the SMF receives the message, it selects a new User Plane Function (UPF) to establish the first Packet Data Unit (PDU) session between the UE (104) and the SMF.

An estimate of a location of the UE (104) may be referred to as a location, location estimate, and may be geographic, thus providing location coordinates for the UE (104) (e.g., latitude and longitude) which may or may not include an altitude component (e.g., four above sea level, height above or depth below ground level). Alternatively, a location of the UE (104) may be expressed as a civic location (e.g., as a postal address or the designation of some point or small area in a building such as a particular room or floor). A location of the UE (104) may also be expressed as an area or volume (defined either geographically or in civic form) within which the UE (104) is expected to be located with some probability or confidence level A location of the UE (104) may further be a relative location comprising, for example, a distance and direction or relative X, Y (and Z) coordinates defined relative to some origin at a known location which may be defined geographically, in civic terms, or by reference to a point, area, or volume indicated on a map, floor plan or building plan. In the description contained herein, the use of the term location may comprise any of these variants unless indicated otherwise. When computing the location of a UE, it is common to solve for local x, y, and possibly z coordinates and then, if needed, convert the local coordinates into absolute ones.

In an embodiment, the network (106) includes, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network (106) also includes, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

The LMF (110) receives the request(s) from the network element(s) (108). On receiving the requests, the LMF (110) processes the received requests by the hypertext transfer protocol version 2 (HTTP2) stack. In an example, each request includes at least one or more of a unique header, a plurality of data frames, a stream Id value, required quality of service (QoS), a list of supported geographical area description (GAD) shapes, and a type of LCS client. The HTTP2 stack is configured to receive the plurality of data frames in a sequential order. On processing the received request, the HTTP2 stack consolidates the unique header and the plurality of data frames with respect to each request to generate a single object. In an aspect, the HTTP2 stack includes multiple listeners for handling incoming requests from the user and performing a number of tasks such as accepting and processing HTTP requests, managing connections, and generating HTTP responses. In another aspect, the HTTP2 stack includes at least one request counter, and at least one response counter for verifying a current incoming request threshold. In an embodiment, the HTTP2 stack is configured to handle the various requests received by an LMF server, connected with the system, from the network elements (108) and to process pending requests based on a configured time. Further, the HTTP2 stack connects to an end node channel in the system (120) to handle disruptions in the network (106).

The LMF (110) extracts the stream Id value corresponding to each request of the received requests. The LMF (110) determines a current location of the target UE based on a number of parameters including downlink location measurements obtained from the UE (104), uplink location measurements obtained from a NG-RAN (Next Generation Radio Access Network), location measurements obtained from a public land mobile network (PLMN), a determined quality of service (QoS), and the type of LCS client. After determining the current location of the UE, the LMF (110) transmits, via the HTTP2 stack, determined current location to the at least one network element (108).

In an embodiment, the system (120) is implemented as a location management function (LMF) (110) that manages the overall co-ordination and scheduling of resources required for the location of the UE (104) that is registered with or accessing the network (106). The system (120) also is configured to calculate a final location, a velocity estimate, and may estimate the achieved accuracy. The system (120) interacts with the UE (104) in order to exchange location information applicable to UE assisted, UE based position methods. Further, the system (network entity (110)) interacts with a new generation-radio access network (NG-RAN), a non-third generation partnership project (3GPP) interworking function (N3IWF), or a trusted non-3GPP access network (TNAN) in order to obtain location information. In an embodiment, the system (120) includes an integrated hypertext transfer protocol 2 (HTTP2) stack for efficiently handling various requests from the UEs (104). In another the system (120) includes the hypertext transfer protocol 2 (HTTP2) stack for efficiently handling various requests from the network elements (108).

In an operative aspect, the LMF (110) is configured to interact with the UE (104) in order to exchange location information applicable to UE assisted methods, and UE based position methods, and is further configured to interact with the NG-RAN, a non-3GPP Interworking Function (N3IWF) and a trusted non-3GPP access network (TNAN) in order to obtain location information.

In a practical aspect, the LMF (110) is configured to be employed as a plug and play for an application catering HTTP2 requests and HTTP2 responses.

Further, the LMF (110) is configured to support a request for periodic or triggered location received from the at least one serving AMF for the target UE and send determined UE location directly to the GMLC. The system (120) provides UE location estimates directly to the gateway mobile location centre (GMLC) for periodic or triggered location of the target UE (104). In an embodiment, the system (120) provides cancelation of a periodic or a triggered location for the target UE (104).

In an embodiment, the system (120) enables a provision of broadcast assistance data to the UE (104) via the NG-RAN in a ciphered form or an unciphered form and forwards any ciphering keys to subscribed UEs (104) via the AMF.

In an embodiment, the system (120) enables a downlink determination of the UE (104) and may receive downlink location measurements, or a location estimate from the UE (104).

In an embodiment, the system (120) receives uplink location measurements and non-UE associated assistance data from the NG-RAN. Further, the system (120) provides broadcast assistance data to UEs (104), and forwards associated ciphering keys to the AMF.

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

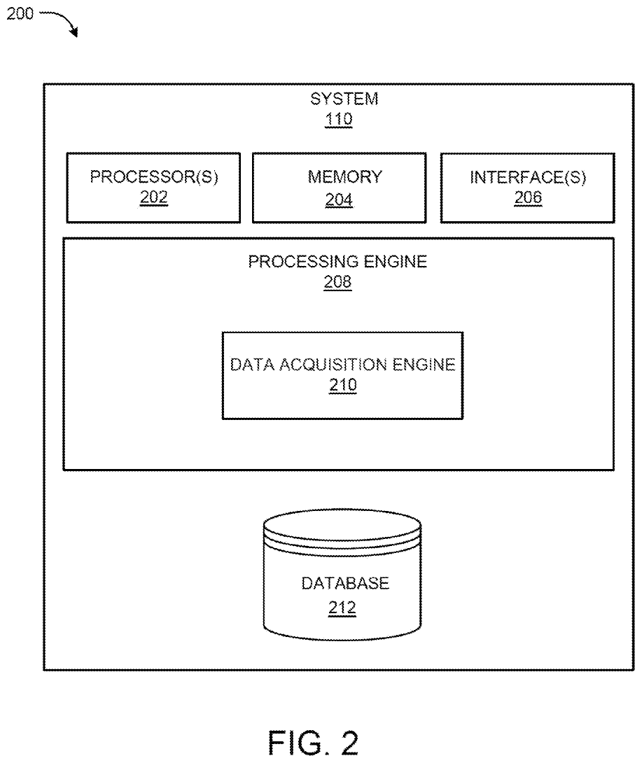

FIG. 2 illustrates an exemplary representation (200) of the system (120), in accordance with an embodiment of the present disclosure.

Referring to FIG. 2, the system (120) includes one or more processor(s) (202). The one or more processor(s) (202) may be implemented as one or more microprocessors, microcomputers, microcontrollers, digital signal processors, central processing units, logic circuitries, and/or any devices that process data based on operational instructions. Among other capabilities, the one or more processor(s) (202) is configured to fetch and execute computer-readable instructions stored in a memory (204) of the system (120). The memory (204) is configured to store one or more computer-readable instructions or routines in a non-transitory computer readable storage medium, which may be fetched and executed to create or share data packets over a network service. The memory (204) includes any non-transitory storage device including, for example, volatile memory such as random-access memory (RAM), or non-volatile memory such as erasable programmable read only memory (EPROM), flash memory, and the like.

In an embodiment, the system (120) includes an interface(s) (206). The interface(s) (206) includes a variety of interfaces, for example, interfaces for data input and output devices (I/O), storage devices, and the like. The interface(s) (206) facilitates communication through the system (120). The interface(s) (206) also provides a communication pathway for one or more components of the system (120). Examples of such components include, but are not limited to, processing engine(s) (208) including a data acquisition engine (210), and a database (212).

The processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system may comprise the machine-readable storage medium storing the instructions and the processing resource to execute the instructions, or the machine-readable storage medium may be separate but accessible to the system and the processing resource. In other examples, the processing engine(s) (208) may be implemented by electronic circuitry.

In an embodiment, the processor (202) may receive one or more requests from a network element (108) (or the UE (104)) via the data acquisition engine (210). The processor (202) may store the one or more requests in the database (212). The processor (202) may enable a location determination based on the received one or more requests where the location determination may include, but not be limited to, key attributes, geodetic position, civic location, and positioning methods.

In an embodiment, the processor (202) determines the current location information to authorized emergency support bodies via a mobile location protocol (MLP) and an orthogonal multiple access (OMA) message exchange.

In an embodiment, the processor (202) transfers/transmits positioning related information between a NG-RAN node and the LMF/system (120).

In an embodiment, the processor (202) sends an observed time difference of arrival (OTDOA) information to the NG-RAN node and receives the OTDOA information applicable to relevant cells of the UE (104).

In an embodiment, the processor (202) receives concurrent requests for the same UE (104) in mutually exclusive sessions and simultaneously handles the concurrent requests.

In an embodiment, the system (120) is configured to manage co-ordination and scheduling of a plurality of resources required for the location of the target UE.

In an embodiment, the system (120) is configured to verify the determined UE location by performing a latitude/longitude/velocity estimation procedure.

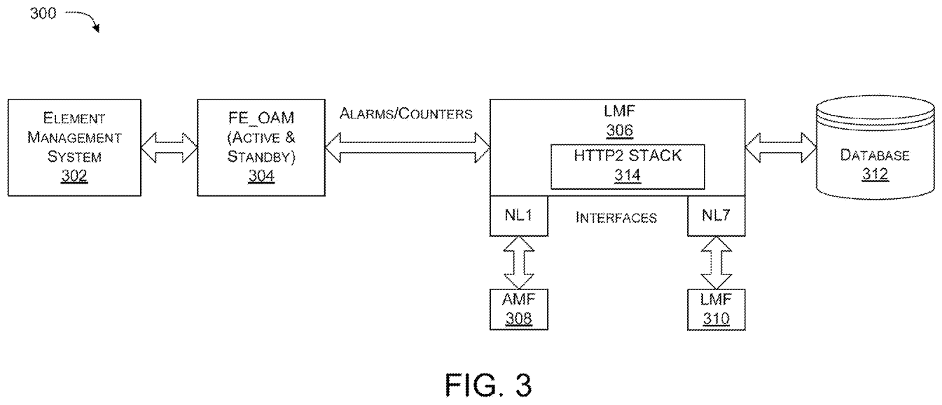

FIG. 3 illustrates an exemplary process (300) for implementing the system (120), in accordance with an embodiment of the present disclosure. A person with ordinary skill in the art may understand that the network entity (306), the LMF (306) described in FIG. 3 is similar to the system (120)/LMF (110) of FIG. 1 in its functionality.

As illustrated in FIG. 3, an element management system (EMS) (302) provides a common view of fault, configuration, accounting, performance, and security (FCAPS) for all micro services associated with the LMF (306). In an embodiment, the EMS (302) includes one or more EMS agent processes along with the instances of one or more subsystems associated with the LMF (306). The agents communicates with a central EMS process for FCAPs and includes various key functionalities supporting solution components.

In an embodiment, the LMF (306) is connected to the at least one serving AMF (308) via an interface NL1. Further, the LMF (306) is connected to another LMF (310) via an interface NL7.

In an embodiment, the LMF (306) includes the HTTP2 stack (314) that receives the requests via the AMF (308). The HTTP2 stack (314) uses a HTTP2 protocol, and has components like a unique header frame, a data frame, a setting, and one or more streams. Each request possessing the header as well as the data frame are unique in itself based on a stream identification (ID) value. In an example, the request include multiple data frames (depending on the size of content), received at the HTTP2 stack (314) in a sequential approach. The HTTP2 stack (314) is configured to provide multiple channels with single client support based on the configuration provided.

In an embodiment, the HTTP2 stack (314) includes different listeners to handle a high time-sensitive packet switch (TPS) which contain different header and data frames for different requests. Based on the stream Id value of each request, the HTTP2 stack (314) consolidates the entire header and the data frames with respect to a single request into a single type of object known as a full such as “HttpRequestPojo”. Once all data frames are bundled up into a single object and ready to process, the data frames are available to listeners for further processing. A similar process is followed for a request as well as a response processing. The HTTP/2 stack (314) is a set of protocols and mechanisms designed to enhance the performance of web communication. Built on a binary framing layer, the HTTP/2 stack facilitates efficient parsing and organization of messages into smaller frames, enabling multiplexing that allows concurrent streams over a single connection. The HTTP/2 stack (314) incorporates header compression, reducing the overhead associated with headers, and introduces priority and dependency management to optimize resource allocation. Server push anticipates client needs by proactively sending resources, and flow control prevents congestion. Optionally, encryption using TLS ensures secure communication. The HTTP/2 stack's comprehensive features contribute to faster page loads, reduced latency, and an improved overall web browsing experience. The HTTP2 stack (314) also includes a request and a response processing counter to verify the current incoming request threshold. The HTTP2 stack is configured to operate on top of the HTTP2 Protocol and includes several components such as header frame, data frame, setting, and streams. Each request that passes through the HTTP2 stack is assigned a unique Stream Id value, which enables it to be easily identified. Moreover, the stack can handle requests that contain multiple data frames, which are received in a sequential manner. Additionally, the stack is configured to handle multiple channels, thereby supporting a single client with a wide range of configurations. Overall, the HTTP2 stack is an efficient and reliable tool that can help users streamline their communication protocols.

In an embodiment, an operation, administration, and maintenance (OAM) module (304) is configured to manage the micro service instances and use an interface for sending FCAPS related information from the EMS (302) to the LMF (306). Further, the LMF (306) receives alarms and counters from the OAM module (304).

In an embodiment, a database (DB) (312) is responsible for data storage corresponding to the LMF (306) and includes an open source, advanced key-value store. The DB (312) is referred as a data structure server where keys may contain strings, hashes, lists, sets, and sorted sets. In an example, for an LMF cluster mode architecture, a key DB redundancy (Master 1, 2 . . . N) technique is used. If a master goes down, then a respective slave becomes master and processes a traffic received from the UEs (104). Further, if the slave goes down, then the master processes the traffic received from the UEs (104). It may be appreciated that the DB (312) is similar to the database (212) of FIG. 2 in its functionality.

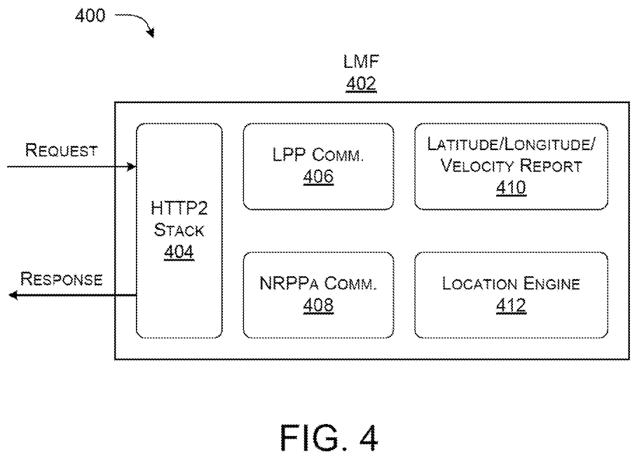

FIG. 4 illustrates an exemplary process (400) used by the system (120) or an LMF (402), in accordance with an embodiment of the present disclosure.

As illustrated in FIG. 4, the LMF (402) includes the HTTP2 stack (404), a long-term evolution (LTE) positioning protocol (LPP) communication module (406), a 5G new radio (NR) positioning protocol (NRPPa) communication module (408), a latitude/longitude/velocity report module (410), and a location engine module (412). The LMF (402) receives the requests from the UE (104) and transmits the determined current location (a response) to the UE (104). It may be appreciated that the LMF (402) is similar to the LMF (110) of FIG. 1 and the LMF (306) of FIG. 3.

In an embodiment, the NRPPa communication module (408) includes various procedures for transferring of positioning-related information between the NG-RAN node and the LMF (402). The location engine module (412) is configured to process periodic or on demand location information. Further, the LPP communication module (406) is configured to integrate with the AMF (308) (as illustrated in FIG. 3) to fully serve the network induced requests from the UEs (104). The LPP communication module (406) is configured to provide location information to the 5G location service (LCS) client based on the triggers received from the AMF (308).

In an embodiment, the latitude/longitude/velocity report module (410) is configured to determine the key attributes like geodetic position, civic location, positioning methods, or the like associated with the UEs (104).

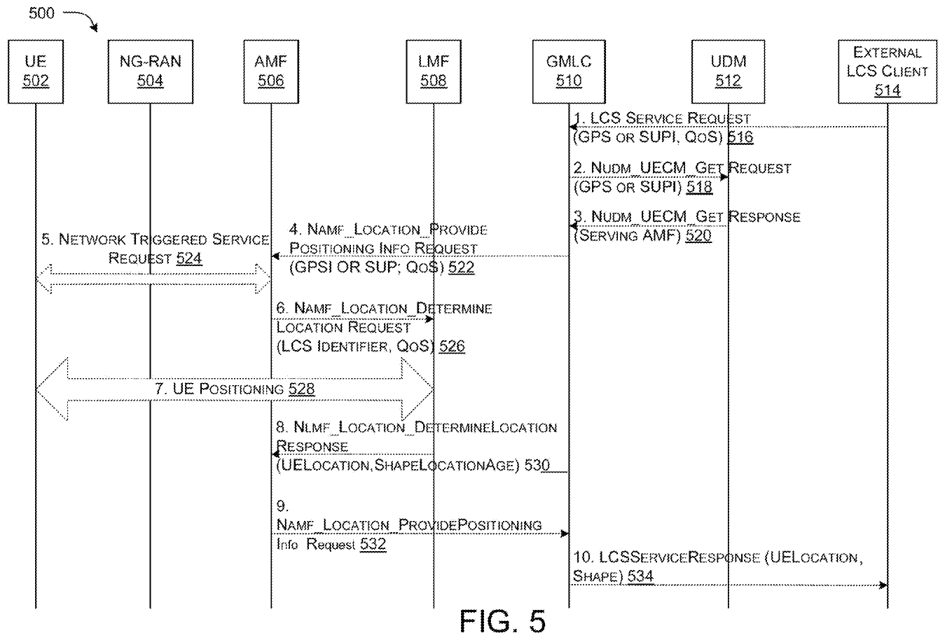

FIG. 5 illustrates an exemplary mobile terminating-location request (MT-LR) process (500) used by the system (120) or the LMF (508), in accordance with an embodiment of the present disclosure.

As illustrated in FIG. 5, the following steps are utilized by the LMF (508) for executing the MO-LR process (500).

At step 516: The external LCS (514) sends a request to the GMLC (510) for a location of the target UE (502) identified by a general public subscription identifier (GPSI), or a subscriber unified permanent identifier (SUPI). The request includes the required QoS, supported geographical area description (GAD) shapes and a client type.

At step 518: The GMLC (510) invokes a Nudm_UECM_Get service operation towards a unified data manager (UDM) (512) of the target UE (502) to be located with the GPSI or SUPI of the UE (502).

At step 520: The UDM (512) returns the network addresses of the current serving AMF (506) to the GMLC (510).

At step 522: The GMLC (510) invokes the Namf_Location_ProvidePositioningInfo service operation towards the AMF (506) to request the current location of the UE (502).

At step 524: The AMF (506) initiates a network triggered service request procedure if the UE (502) is in a connection management (CM) IDLE state.

At step 526: The AMF (506) selects the LMF (508) based configuration and invoke Nlmf_Location_DetermineLocation service operation towards the LMF (508) to request the current location of the UE (502).

At step 528: The LMF (508) performs one or more of the positioning procedures based on QoS. The LMF (508) uses the Namf_Communication_N1N2MessageTransfer service operation to request the transfer of a positioning related N1 message to the UE (502) or the transfer of a network positioning message to the serving NG-RAN (504) node for the UE (502).

At step 530: The LMF (508) returns the Nlmf_Location_DetermineLocation response towards the AMF (506) to return the current location of the UE (502).

At step 532: The AMF (506) returns the Namf_Location_ProvidePositioningInfo response towards the GMLC (510)/location retrieval function (LRF) to return the current location of the UE (502).

At step 534: The GMLC (510) sends a location service response (LSR) to the external LCS client (514).

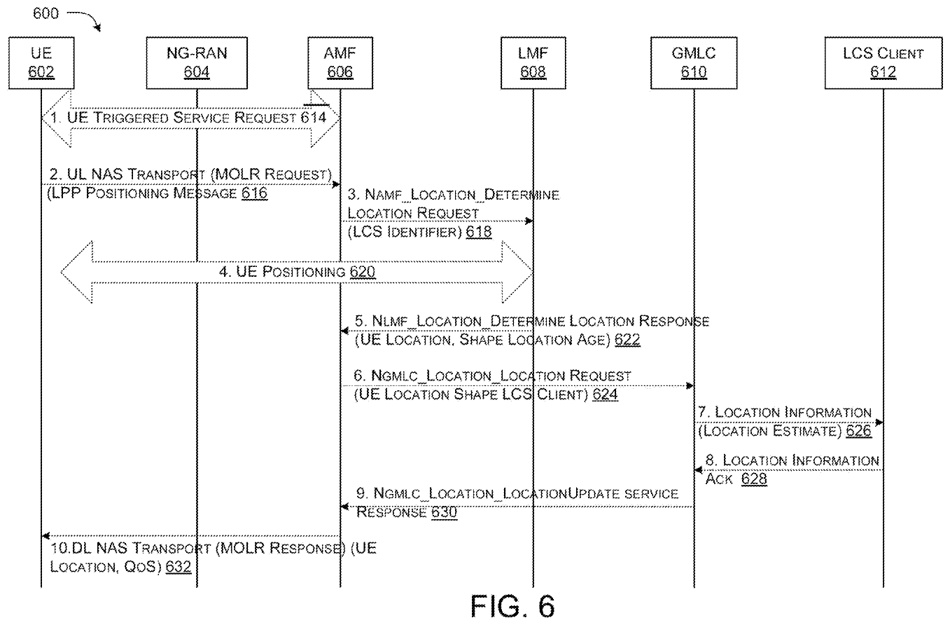

FIG. 6 illustrates an exemplary mobile originating-location request (MO-LR) process (600) used by the system (120) or the LMF (608), in accordance with an embodiment of the present disclosure.

As illustrated in FIG. 6, the following steps are utilized by the LMF (608) for executing the MO-LR process (600).

At step 614: If the UE (602) is in a CM-IDLE state, the UE (602) initiates the UE triggered service request.

At step 616: The UE (602) sends an MO-LR request message included in an uplink (UL) network attached-storage (NAS) transport message. The MO-LR request optionally includes the LPP positioning message.

At step 618: The AMF (606) selects the LMF (608) based on configuration and invoke Nlmf_Location_DetermineLocation service operation towards the LMF (608) to request the current location of the UE (602).

At step 620: The LMF (608) performs one or more of the positioning procedures based on the QoS. Further, the LMF (608) uses the Namf_Communication_N1N2MessageTransfer service operation to request the transfer of a positioning related N1 message to the UE (602). The LMF (608) transfers a network positioning message to the serving NG-RAN (604) node for the UE (602).

At step 622: The LMF (608) returns the Nlmf_Location_DetermineLocation response towards the AMF (606) to return the current location of the UE (602).

At step 624: The AMF (606) invokes the Ngmlc_Location_LocationUpdate service operation towards to the GMLC (610).

At step 626: The GMLC (610) transfers the location information to the LCS client (612) as per a local configuration.

At step 628: The LCS client (612) sends the location information ACK message to the GMLC (610).

At step 630: Upon receiving ACK from the LCS client (612), the GMLC (610) sends Ngmlc_Location_LocationUpdate service response to the AMF (606).

At step 632: The AMF (606) sends an MO-LR response message included in a downlink (DL) NAS TRANSPORT message. The response carries a location estimate requested by the UE (602).

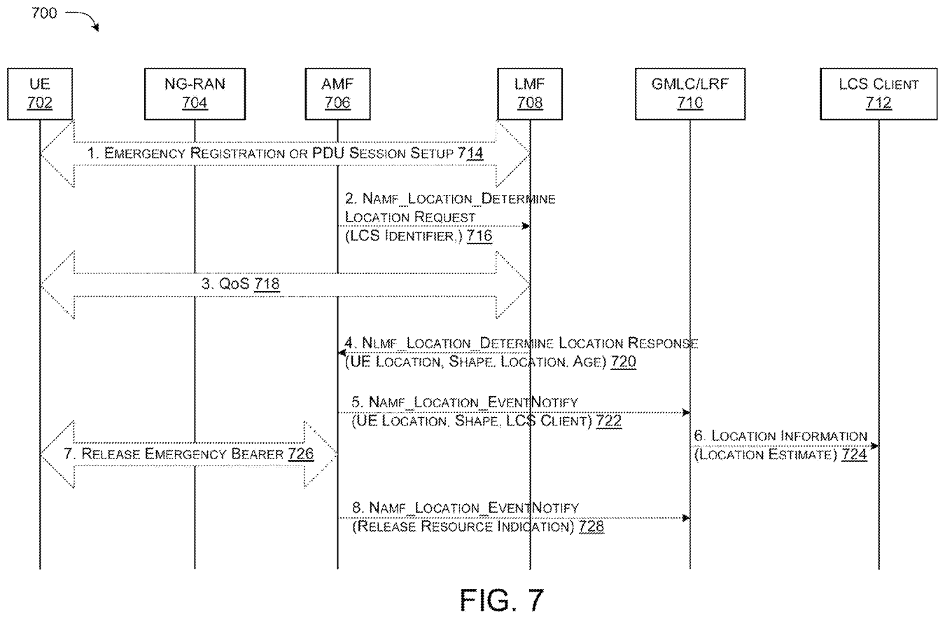

FIG. 7 illustrates an exemplary network induced-location request (NI-LR) (700) used by the system (120) or the LMF (708), in accordance with an embodiment of the present disclosure.

As illustrated in FIG. 7, the UE (702) initiates an emergency session or other sessions using NG-RAN (704) during the NI-LR procedure. The NI-LR procedure may assume that the serving AMF (606) is informed of the regulatory service associated with the session.

At step 714: The UE (702) registers with a 5G core (5GC) for emergency services or request the establishment of a protocol data unit (PDU) session related to an applicable regulatory service.

At step 716: The AMF (706) selects the LMF (708) based configuration and invoke Nlmf_Location_DetermineLocation service operation towards the LMF (708) to request the current location of the UE (702).

At step 718: The LMF (708) performs one or more of the positioning procedures based on QoS and use the Namf_Communication_N1N2MessageTransfer service operation to request the transfer of a positioning related N1 message to the UE (702). The LMF (708) transfers a network positioning message to the serving NG-RAN (704) node for the UE (702).

At step 720: The LMF (708) returns the Nlmf_Location_DetermineLocation response towards the AMF (706) to return the current location of the UE (702).

At 722: step The AMF (706) invokes the Namf_Location_EventNotify service operation towards the selected GMLC/LRF (710) to notify the GMLC/LRF (710) of an emergency session initiation.

At step 724: The GMLC (710) forwards the location to an external emergency services client.

At step 726: For emergency services, the emergency services session and emergency PDU session are released from the GMLC/LRF (710) to the LCS client (712).

At step 728: For emergency services, the AMF (706) invokes the Namf_Location_EventNotify service operation towards the GMLC/LRF (710) to notify the GMLC/LRF (710) that the emergency session is released to enable the GMLC/LRF (710).

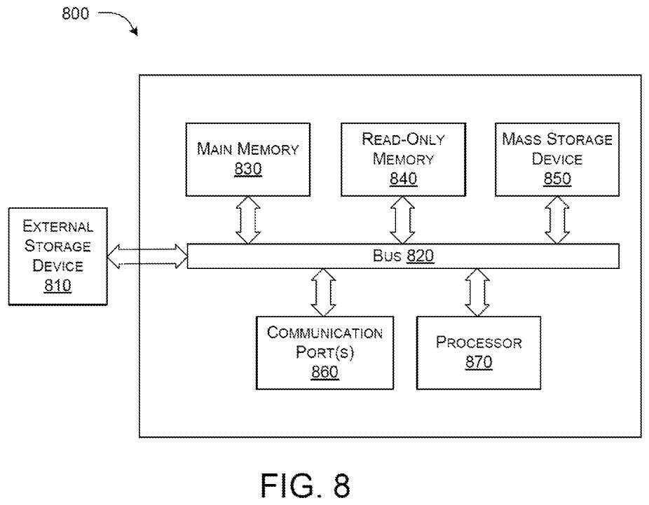

FIG. 8 illustrates an exemplary computer system (800) in which or with which the system/LMF (110) may be implemented, in accordance with an embodiment of the present disclosure.

As shown in FIG. 8, the computer system (800) includes an external storage device (810), a bus (820), a main memory (830), a read-only memory (840), a mass storage device (850), a communication port(s) (860), and a processor (870). A person skilled in the art will appreciate that the computer system (800) may include more than one processor and communication ports. The processor (870) may include various modules associated with embodiments of the present disclosure. The communication port(s) (860) is any of an RS-232 port for use with a modem-based dialup connection, a 10/100 Ethernet port, a Gigabit or 10 Gigabit port using copper or fiber, a serial port, a parallel port, or other existing or future ports. The communication ports(s) (860) is chosen depending on a network, such as a Local Area Network (LAN), Wide Area Network (WAN), or any network to which the computer system (800) connects.

In an embodiment, the main memory (830) may be Random Access Memory (RAM), or any other dynamic storage device commonly known in the art. The read-only memory (840) may be any static storage device(s) e.g., but not limited to, a Programmable Read Only Memory (PROM) chip for storing static information e.g., start-up or basic input/output system (BIOS) instructions for the processor (870). The mass storage device (850) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (820) is communicatively couple the processor(s) (870) with the other memory, storage, and communication blocks. The bus (820) may be, e.g. a Peripheral Component Interconnect PCI)/PCI Extended (PCI-X) bus, Small Computer System Interface (SCSI), universal serial bus (USB), or the like, for connecting expansion cards, drives, and other subsystems as well as other buses, such a front side bus (FSB), which connects the processor (870) to the computer system (800).

In another embodiment, operator, and administrative interfaces, e.g., a display, keyboard, and cursor control device may also be coupled to the bus (820) to support direct operator interaction with the computer system (800). Other operator and administrative interfaces can be provided through network connections connected through the communication port(s) (860). Components described above are meant only to exemplify various possibilities. In no way should the aforementioned exemplary computer system (800) limit the scope of the present disclosure.

The present disclosure is configured to provide an enhancement to the LMF such that the enhanced LMF is able to use single TCP connection to send multiple streams of data at once so that no one resource blocks any other resource., thereby increasing the performance of a communication network. The updated LMF architecture includes a HTTP 2 stack which is configured to receive multiple data frames in a sequential approach. The integration of HTTP2 Stack within the LMF is like plug and play mode. The HTTP2 Stack is used as library and call its APIs for server or client initialization The present disclosure is applicable to a wide range of applications that require real-time position and location of the user equipments. With the fast advances of 5G standardization, the present disclosure may be applicable to location-based services-related use cases, industrial use cases including trolley location, container handling, manufacturing, and road-related use cases include traffic monitoring, management, and control.

The method and system of the present disclosure may be implemented in a number of ways. For example, the methods and systems of the present disclosure may be implemented by software, hardware, firmware, or any combination of software, hardware, and firmware. The above-described order for the steps of the method is for illustration only, and the steps of the method of the present disclosure are not limited to the order specifically described above unless specifically stated otherwise. Further, in some embodiments, the present disclosure may also be embodied as programs recorded in a recording medium, the programs including machine-readable instructions for implementing the methods according to the present disclosure. Thus, the present disclosure also covers a recording medium storing a program for executing the method according to the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### ADVANTAGES OF THE INVENTION

The present disclosure provides a system and a method that is capable to manage incoming requests in an efficient manner with the help of an integrated hypertext transfer protocol 2 (HTTP 2) stack, thereby improving the efficiency and speed of the system.

The present disclosure provides a system and a method where the HTTP2 stack functionality is integrated within a location management function (LMF) to handle various incoming requests efficiently.

The present disclosure provides a system and a method where the HTTP2 stack functionality provides bundled up formation for all data chunks and provides readymade information that can be easily processed.

The present disclosure provides a system and a method where the HTTP2 stack functionality retries pending requests based on configured time and uses a retry channel functionality to prevent disconnections.

The present disclosure provides a system and a method where the LMF manages the overall co-ordination and scheduling of resources required for the location of a user equipment (UE) that is registered with or accessing a network.

The present disclosure provides a system and a method where the LMF calculates or verifies a final location and a velocity estimate to achieve the desired accuracy.

The present disclosure provides a system and a method where the LMF interacts with the UE in order to exchange location information applicable to UE assisted, UE based position methods.

The present disclosure provides a system and a method where the LMF interacts with a new generation-radio access network (NG-RAN), a non-third generation partnership project (3GPP) interworking function (N3IWF), or a trusted non-3GPP access network (TNAN) in order to obtain location information.

The present disclosure provides a system and a method that enhances a tractability function and further enhances the communication system.

We claim:

1. A system (120) for providing location assistance in a network (106), said system (120) comprising:
at least one network element (108) configured to generate at least one request for providing a location of a target user equipment (UE); and
a location management function (LMF) (110) having a hypertext transfer protocol version 2 (HTTP2) stack (112) coupled to said at least one network element to receive said generated request and is configured to:
process said received request to determine a current location of said target UE based on a number of parameters; and
communicate said determined current location to said at least one network element.

2. The system (120) as claimed in claim 1, wherein said at least one network element (108) includes at least one serving Access and Mobility Management Function (AMF), a gateway mobile location centre (GMLC), and a location services (LCS) client.

3. The system (120) as claimed in claim 1, wherein each request includes at least one or more of a unique header, a plurality of data frames, required quality of service (QoS), a list of supported geographical area description (GAD) shapes, and a type of LCS client.

4. The system (120) as claimed in claim 3, wherein said HTTP2 stack (112) is configured to receive said plurality of data frames in a sequential order.

5. The system (120) as claimed in claim 1, wherein said number of parameters include downlink location measurements obtained from said target UE, uplink location measurements obtained from a NG-RAN (Next Generation Radio Access Network), location measurements obtained from a public land mobile network (PLMN), a determined quality of service (QoS), and said type of LCS client.

6. The system (120) as claimed in claim 1, wherein said HTTP2 stack (112) includes multiple listeners for handling incoming requests from said at least one network element and performing a number of tasks such as accepting and processing HTTP requests, managing connections, and generating HTTP responses.

7. The system (120) as claimed in claim 1, wherein said HTTP2 stack (112) is configured to extract a stream Id value corresponding to each received request.

8. The system (120) as claimed in claim 1, wherein said HTTP2 stack (112) is configured to consolidate said unique header and said plurality of data frames based on said extracted stream Id value to generate a single object.

9. The system (120) as claimed in claim 1, is configured to interact with said target UE in order to exchange location information applicable to UE assisted methods, and UE based position methods, and is further configured to interact with a plurality of resources in order to obtain the location information.

10. The system (120) as claimed in claim 1, wherein said plurality of resources includes said NG-RAN, a non-3GPP Interworking Function (N3IWF) and a trusted non-3GPP access network (TNAN).

11. The system (120) as claimed in claim 1, wherein said HTTP2 stack (112) includes at least one request counter, and at least one response counter for verifying a current incoming request threshold.

12. The system (120) as claimed in claim 1, where said LMF (110) is configured to be employed as a plug and play for an application catering HTTP2 requests and HTTP2 responses.

13. The system (120) as claimed in claim 1, is configured to support a request for periodic or triggered location received from said at least one serving AMF (108) for said target UE and send determined UE location directly to said GMLC.

14. The system (120) as claimed in claim 1, is configured to manage co-ordination and scheduling of said plurality of resources required for the location of said target UE.

15. The system (120) as claimed in claim 1, is configured to verify said determined UE location by performing a latitude/longitude/velocity estimation procedure.

16. A network entity for providing location assistance in a network, said network entity is coupled to at least one network element that is configured to generate at least one request for providing a location of a target user equipment (UE), said network entity comprising:
a location management function (LMF) having a hypertext transfer protocol version 2 (HTTP2) stack coupled to said at least one network element to receive said generated at least one request and is configured to:
process said received request to determine a current location of said target UE based on a number of parameters; and
communicate said determined current location to said at least one network element.

17. A method of providing location assistance in a network, said method comprising:
generating, by at least one network element (108), at least one request for providing a location of a target user equipment (UE);
receiving, by a location management function (LMF) (110) having a hypertext transfer protocol version 2 (HTTP2) stack (112), said generated at least one request from said at least one network element;
processing, by said LMF (110), said received request to determine a current location of said target UE based on a number of parameters; and
communicating, via said LMF (110), said communicate said determined current location to said at least one network element (108).

18. A computer program product comprising a non-transitory computer-readable medium comprising instructions that, when executed by one or more processors, cause the one or more processors to perform:
generate, by at least one network element, at least one request for providing a location of a target user equipment (UE)
receive, by a location management function (LMF) having a hypertext transfer protocol version 2 (HTTP2) stack, said generated at least one request from said at least one network element;
process, by said LMF, said received request to determine a current location of said target UE based on a number of parameters; and
communicate, via said LMF, said communicate said determined current location to said at least one network element.

19. A user equipment for providing location assistance in a network, said user equipment comprising:
a processor; and
a computer readable storage medium storing programming for execution by said processor, the programming including instructions to:
generate, by at least one network element, at least one request for providing a location of a target user equipment (UE);
receive, by a location management function (LMF) having a hypertext transfer protocol version 2 (HTTP2) stack, said generated at least one request from said at least one network element;
process, by said LMF, said received request to determine a current location of said target UE based on a number of parameters; and
communicate, via said LMF, said communicate said determined current location to said at least one network element.
